(19) United States
(12) Patent Application Publication
(10) Pub. No.: US 2005/0272605 A1
(43) Pub. Date: Dec. 8, 2005

(54) Method to treat seeds

(76) Inventor: Rosemary Bradley, Perez Zeledon (CR)

Correspondence Address: Dodds & Associates, 1707 N Street NW, Washington, DC, 20036, US

(21) Appl. No.: 10/515,143

(22) PCT Filed: Jun. 12, 2003
(86) PCT No.: PCT/US03/18691

§ 371 Date: Nov. 19, 2004

(30) Foreign Application Priority Data
Jun. 19, 2002 (GB) 0214100.0

(51) Int. Cl. A01N 25/26

(52) U.S. Cl. 504/100

(57) ABSTRACT

A method for reducing dormancy and improving the germination of seeds is provided. Treatment of seeds with aqueous aerated nitrate solution can be used for previously scarified seeds or for seeds not scarified before. The treatment can also be given in non-aqueous form. The treatment remarkably improves the germination of plant seeds, especially of grass species.

This is a submission to enter the national stage under 35 U.S.C. section 371. The international application WO2004/000024 has been published on Dec. 31, 2003. The PCT application claims priority of national application No. GB 0214100.0 filed in the United Kingdom on Jun. 19, 2004.

### TECHNICAL FIELD OF THE INVENTION

This invention is related to process of treating seeds, and more particularly to a process for treating seeds to reduce seed dormancy and enhance seed germination.

### BACKGROUND ART OF THE INVENTION

Many seeds, and in particular tropical grass seeds display a phenomenon known as “seed dormancy” after harvest. This means that a certain period of time must elapse before a reasonable level of germination of the seeds can be obtained. The length of time varies and depends upon the type and deepness of the dormancy. The dormancy may be physical as a result of a hard seed coat, or physiological, probably due to enzyme inhibition, or it may be a combination of the two. Dormancy can also be affected by the methods used to harvest and dry the seeds, and does in addition, vary between species. Furthermore, secondary dormancy may be present as a result of other factors such as thermic shock, or as a result of the transportation of the seeds in a non-pressurized aircraft. The level of dormancy can be measured as the difference between viability (as measured by the tetrazolium test), and germination on moist paper.

In order to maximize the germination of seeds and to gain some control over the period of time that must elapse between the harvesting and germination of seeds, various methods have been tried to reduce the dormancy of seeds. In particular the scarification of seeds has been used for increasing germination. Scarification however, is generally expensive and it reduces the seed weight. It may also reduce the time for which the seeds can be stored.

The scarification of the seeds breaks down the seed coats, either chemically, usually by soaking the seed in concentrated sulphuric acid, or mechanically by the use of physical abrasion with sandpaper or other abrasive surface. U.S. Pat. Nos. 4,931,079 and 4,834,788 describe a method to chemically treat plant seeds by contacting the seeds with an aqueous solution containing urea and sulfuric acid.

Patent SU1639453A discloses a method to treat wheat seeds with magnesium nitrate-hexa dimethylurea to increase germination. SU 1353338 discloses a method to activate vegetable seeds by treating them in phosphate-nitrate solution.

Soaking seeds in nitrate-phosphate solution has also been disclosed in UK patent No. 304,649. This patent provides a method to separate seeds based on the fact that lighter seeds will rise in the solution and heavier seeds will sink or settle in the solution.

Mechanical seed-treating methods, such as mechanical scarification involve the use of relatively complicated equipment. Another problem with mechanical scarification is that the known methods do not always result in homogenous scarification.

U.S. Pat. No. 5,703,009 discloses a method to improve seed germination by treating the seeds with gaseous ozone. This method needs high technology and is therefore not easy to use.

For vegetable seeds a method requiring sophisticated equipment may be suitable, but such a method would be too costly for application to large volumes of seed, as in the case of tropical grass seed.

In the case of tropical grass seeds, an alternative to reduce dormancy is to harvest the seeds from the soil surface. This procedure has been found to be useful particularly in Brazil, for harvesting of Brachiaria brizantha and Brachiaria decumbens. However, even when this method of harvest is used in conjunction with subsequent acid-scarification, a dormancy period of about three months may still exist. This might not be a problem if the seeds are to be planted in the country of harvest, but it certainly is a problem when the seeds are exported to countries in the opposite hemisphere where the planting season begins before the end of the seed dormancy.

It has been believed until this that it is not possible to dry and store grass seeds, which have been treated to stimulate germination, without deterioration.

Accordingly, there is a need for a process for the treatment of large quantities of seeds, which can assist in the removal of seed dormancy and thus improve the germination of seeds.

Furthermore, there is a need for a process for treating seeds, which process would allow drying and storing the seeds afterwards without harmful effect to the seeds.

It is therefore an object of this disclosure to provide a process for treating seeds to reduce the effects of dormancy and improve germination.

Another object of this disclosure is to provide a non-expensive and easy to use method for treating seeds to reduce the effects of dormancy and improve germination.

A further object of the present disclosure is to provide a method that can also be used or previously scarified seeds.

A still another object of the present disclosure is to provide a method for seeds of various plant species.

A further object of the present disclosure is to provide a method for seeds of various grass species.

A still another object of the present disclosure is to improve seedling vigor.

### DESCRIPTION OF THE INVENTION

The present disclosure provides a process for treating seeds to reduce the effects of dormancy. The process includes providing a nitrate salt and bringing the seeds into contact with the nitrate salt for a period of time.

According to one preferred embodiment of the invention the seeds are immersed in an aqueous solution of a nitrate salt. According to the most preferred embodiment of the invention, the seeds are immersed in a solution of potassium nitrate for a period of from about ten to about thirty-six hours. Preferably the potassium nitrate solution has a concentration of about 0.2%, and in a most preferred option the potassium nitrate solution is aerated. Preferably the seeds will be allowed to drain for a period of about 12 hours subsequent to their soaking. Preferably the seeds are dried after draining.

It is further preferred that tanks in which the seeds are immersed are provided with means to supply a constant flow of compressed air to aerate the nitrate solution. It has been found that optimum results are obtained when to solution and the seeds are so aerated.

According to another embodiment of the present invention, the seeds may be heaped together in a pile on a concrete or like floor, and a quantity of nitrate salt is added to them. The nitrate is mixed into the seeds with a spade or other suitable implement, and the mixture is covered with an impermeable sheet, such as plastic and left for the required amount of time, after which the seeds are preferably dried. Preferably the nitrate salt is potassium nitrate. This embodiment is especially useful when the prevailing conditions do not allow for the provision of suitable equipment, in which the seeds may be soaked and aerated. It is important that in this embodiment of the invention, seed moisture content is controlled by covering the seeds to minimize uneven dispersion of moisture throughout the seed lot. Such uneven dispersion could result in part of the seed lot being damaged, and an uneven germination rate over the seed lot would result.

According to the preferred embodiment the seeds have been scarified to affect an at least partial breaking down of the seed coat prior to their contact with the nitrate. The scarification may be either chemical, such as soaking the seeds in concentrated sulfuric acid, or physical, such as physical abrasion of the seeds with sandpaper, or any other abrasive surface. While the treatment according to the present invention is effective if the seeds have not previously been scarified it is more effective on seeds that have been scarified; especially efficient the treatment is if the seeds have been previously acid-scarified. The seeds may be treated immediately after acid scarification while they are still wet, or they may be dried after scarification and prior to treatment.

According to one embodiment additional ingredients to enhance germination may be added to the seeds during the process according to this invention. According to the most preferred embodiment the additional ingredients will be gibberellic acid (GA) or smoke extract, which will preferably be added either during the draining, or after the seeds have drained from their immersion in a nitrate solution, or contact with a nitrate salt, but prior to drying. Preferably the amount of additional substances added will be about 500 ml per 10 kg of seeds.

Once the treatment has been completed and the seed have been dried, the visual appearance of the treated seed is identical to that of an untreated seed. However, it has been observed prior to drying, that the micropyle (orifice through which the radicle emerges) of the treated seeds is often open, although the radicle itself has not appeared.

The process according to the present disclosure is particularly suitable for use with grass seeds and while it has been found to be particularly effective with tropical grass seeds it is also suitable for use with other seed species. In particular the process has been used successfully on the following grass species: Brachiaria dictyoneura, Brachiaria humidicola, Brachiaria brizantha, Brachiaria decumbens, Panicum maximum and Paspalum notatum.

While it has been found that acid-scarification alone will normally improve the germination of seeds to a certain extent, a post-scarification treatment according to this disclosure results in a significant improvement in the seed germination. Moreover, the additional costs incurred in the post-scarification treatment according to the present disclosure are not significant when compared with the costs of acid-scarification.

Even if the method according to the present disclosure is successful with various seed species small scale treatment may be needed at first to optimize the variables for each seed type depending on the stage of dormancy they have. For example a small tank fitted with an aquarium pump can be used to immerse and aerate a number of bagged samples of different seeds. If the seeds have a particularly remarkable dormancy then it may be necessary to scarify the seeds twice before the treatment. In addition the time of immersion or contact of the seeds with the nitrate, and the need for further additives such as gibberellic acid, can be evaluated as a result of the preliminary tests.

An advantage of the treatment according to the present disclosure is that it appears to be unaffected by variations in temperature over a fairly wide operating range, or by pH. The water used may be chlorinated or unchlorinated. The method according to the present disclosure does not require addition of fungicides.

It has been believed that it is not possible to treat large quantities of seeds to stimulate germination, and then dry and store them without deterioration. Surprisingly, the seeds that have been treated by the process according to this disclosure may be dried and safely stored, with no detrimental effect, for long periods of time.

A further advantage of the method according to this disclosure is that the treatment process is simple to execute and does not require expensive or complex equipment.

An additional advantage of the process for treating seeds in accordance with the invention is that seedling vigor is increased by the treatment.

### BRIEF DESCRIPTION OF DRAWINGS

FIG. 1 illustrates a perspective view of a tank in which the seeds are immersed.

### BEST MODE FOR CARRYING OUT THE INVENTION

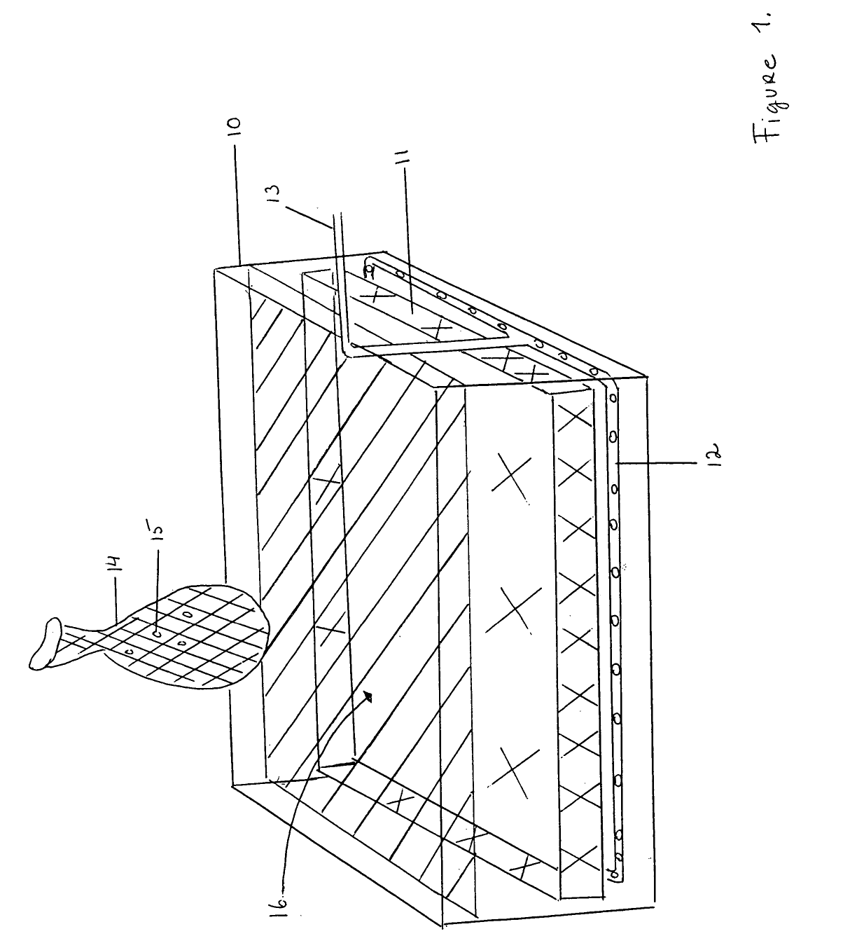

A preferred embodiment is described here by way of example only with reference to FIG. 1, which shows a perspective view of a tank in which the seeds are immersed.

In this embodiment a fiberglass tank 10 is fitted with the wire netting tray 11, which is located at approximately one third of the depth of the tank 10 from the bottom. A perforated pipe 12, which is connected to a compressed air supply 13, is provided underneath the tray 11. About 10 kg of seeds 15 to be treated are placed into a suitably sized bag 14 made from appropriately dimensioned plastic netting. A selected number of these bags are then placed onto the netting tray 11, which separates the bags of seed from the source of compressed air, being the perforated pipe 12 in this embodiment.

The tank is filled with an approximately 0.2% solution of potassium nitrate 16 in water, to level which will ensure that the seed-containing bags are just immersed. The seeds 15 are immersed at ambient temperature for about 10 to about 36 hours, during which time the tank is constantly aerated by a flow of air form the compressed air source through the perforated pipe 12. The bags are then removed form the tank 10 and allowed to drain for about 12 hours. If the seed being treated requires addition of further agents such as gibberellic acid or smoke extract, then suitable quantities of these ingredients in solution are poured over the draining seed, and mixed by hand. The seeds are then dried to between 8% and 14% moisture content, preferably 12% moisture content, and stored as required.

If large quantities of seed are being treated the addition of the further agents is carried out in a mechanical mixer.

The invention will now be further described by way of some examples of data, the results of empirical tests, which show the improved germination of seeds as a result of treatment by way of the process according to this disclosure.

### EXAMPLE 1

Effect of double scarification and nitrate treatment on germination and seedling vigor of Brachiaria dictyoneura seeds.

A lot of Brachiaria dictyoneura seeds were harvested manually (by cutting the panicle and sweating for six days in heaps, and then threshing) in Zapote, Pérez Zeledón, Costa Rica, in July 2000. The seeds were dried in the shade, classified to remove waste and stored at 15° C. and 60% relative humidity for six months. A 30 kg sample of this seed lot was then scarified for 30 minutes with concentrated sulphuric acid on Jan. 4, 2001. The seeds were dried to 12% moisture and then re-scarified for a further 15 minutes on Feb. 26, 2001. After the second scarification the seeds were soaked in potassium nitrate for 24 hours and drained for 12 hours by the process described above.

Small 50 g sub-samples of the same seed lot were also taken, some of which were scarified once or twice but not treated, and some of which only received the first 30-minute scarification, but were treated. The seeds were then dried carefully in the sun until they reached the 12% moisture content. A sample of the nitrate treated, double scarified seed was tested for germination on Mar. 8, 2001, using 3 replicates of 00 pure seeds on a soil-based substrate, at approximately 35° C. during the day, and 15° C. during the night, with florescent and incandescent lighting during the day (12 hours), in closed plastic germination trays. The result was 79% germination after 26 days. The four samples were then stored for a further 7 months when the following germination test was carried out on Nov. 17, 2001, using 4 replicates of 100 seeds on a paper substrate irrigated with water, and the same growth conditions described above. The results are shown in Table I.

TABLE I
Effect of scarification and nitrate treatment on germination
of Brachiaria dictyoneura seeds.

| | % Germination 7 days | |
|---|---|---|
| | (paper + water) | |
| Aerated nitrate treatment | Scarified once | Scarified twice |
| Untreated | 56.25a | 72.25b |
| Treated | 87.25c | 93.00c |

Analysis of the data using ANOVA and Duncan's Multiple Range Test showed a statistically significant effect of the aerated nitrate treatment on germination of seed both with one and two scarifications (different letters indicate a significant difference between means p=0.01). Although the additional acid scarification in non-nitrate-treated seed increased germination significantly from 56% to 72%, the effect of the aerated nitrate treatment was even more marked, giving 87% and 93% germination respectively.

There was an increase of 30% in germination due to nitrate treatment in seeds that had been scarified once, and of 20% in seeds that had been scarified twice.

The germination data after 7 days shows, that the treated seed had practically all germinated by this time, whereas the untreated seed lots still contained 40% and 25% un-germinated seeds. The seedling from the treated seeds also showed greater vigor.

### EXAMPLE 2

Effect of scarification and nitrate treatment on Brachiaria dictyoneura seeds.

A test was carried out in 1996 on a lot of Brachiaria dictyoneura seeds harvested as above in 1995, showing a marked effect of double scarification combined with the nitrate soaking treatment and the addition of GA. The results are shown in Table II.

TABLE II
Effect of scarification and nitrate treatment
on Brachiaria dictyoneura seeds.

| | Treatment | | % Germination 15 |
|---|---|---|---|
| Scarification | Nitrate | GA | days (soil substrate) |
| Once (20 minutes) | − | − | 22.5a |
| Once (20 minutes) | + | − | 42.5b |
| Once (20 minutes) | + | + | 68.0c |
| Twice (20 + 10 | − | − | 70.5cd |
| minutes) | | | |
| Twice (20 + 10 | + | − | 65.0c |
| minutes) | | | |
| Twice (20 + 10 | + | + | 85.5d |
| minutes) | | | |

The seeds (two replicates of 100 seeds) were sown on a soil substrate with the same growth conditions described above.

The data show a large increase in germination, especially when using a combination of all three treatments (double acid scarification, nitrate soaking, and addition of GA), (CV=8.7%, p≧0.01).

This lot of seeds was clearly deeper in dormancy than that described in Example 1 and Table I. Accordingly, the seeds of Example 1 showed high germination with the nitrate treatment and only one scarification without the addition of GA, even when using a paper substrate.

### EXAMPLE 3

Effect of nitrate treatment on acid-scarified Brachiaria brizantha seeds.

Effect of nitrate on a lot of acid-scarified Brachiaria brizantha imported from Brazil in July 2001, shortly after harvesting from the soil surface, using different substrates for the germination test.

The seeds were treated on Aug. 15, 2001 and after drying, samples were taken and tested for germination on Aug. 24, 2001. The soil substrate was maintained at the same moisture level throughout the test by weight. The paper substrate was maintained moist by irrigation from below, using a piece of plastic foam to separate the paper from the water in the base of the tray.

The data in Table III show that when soil was used as a substrate, the effect of the treatment was significant at 7 days but not at 25 days. When paper (Seedburo K-22) was used as a substrate, the effect of the treatment was much more marked. Germination of untreated seed was almost double on soil than on paper. Furthermore, the untreated seed was slower to germinate on paper than on soil, showing a significant difference between 7 and 25 days on paper, but not ton soil. The increased germination of the treated seed was statistically significant both in number and over time (i.e. the treated seed germinated more rapidly).

TABLE III
Effect of nitrate treatment on acid-scarified
Brachiaria brizantha seeds.

| | | % Germination | |
|---|---|---|---|
| Substrate | Nitrate Treatment | 7 days | 25 days |
| Soil | − | 76c | 84cde |
| Soil | + | 88de | 90e |
| Paper | − | 39a | 50b |
| Paper | + | 77cd | 82cde |

However, when soil was used as a substrate, the effect of the treatment was less evident, because the germination of the untreated seed was so much higher on soil than on paper. This indicates that dormant seeds are more susceptible to the substrate used for germination testes than seeds that have been treated to overcome the dormancy.

### EXAMPLE 4

Effects of scarification and nitrate treatment on germination of Paspalum notatum seeds.

Table IV shows the results obtained with a lot of Paspalum notatum (cv. Pensacola) imported form the U.S.A in 1997.

TABLE IV
Effects of scarification and nitrate treatment on germination
of Paspalum notatum seeds.

| Scarification | Treatment | % Germination |
|---|---|---|
| − | − | 51.5 |
| 10 minutes | − | 48 |
| 10 minutes | + | 64.8 |
| 10 + 10 minutes | − | 81 |
| 20 minutes | − | 36.5 |
| 20 minutes | + | 63.5 |

It can be seen that in this seed lot, although the treatments had a positive effect on seeds scarified for 10 and 20 minutes. A better result was obtained by double-scarifying the seed.

### EXAMPLE 5

Effect of scarification and nitrate treatment on germination of Paspalum notatum seeds.

Another lot of Paspalum notatum cv Pensacola imported from the USA in 2001, showed a marked improvement in germination after one scarification and the aerated nitrate treatment. Results are shown in Table V.

TABLE V
Effect of scarification and nitrate treatment on
germination of Paspalum notatum seeds

| Scarification | Treatment | % Germination |
|---|---|---|
| − | − | 40.3 |
| + | + | 79.0 |

### EXAMPLE 6

Effects of scarification and nitrate treatment on the germination of Panicum maximum seeds.

A lot of Panicum maximum cv. Tanzania imported from Bolivia in 1998 gave the results shown in Table VI.

TABLE VI
Effects of scarification and nitrate treatment on the
germination of Panicum maximum seeds

| Scarification | Treatment | % Germination |
|---|---|---|
| − | − | 29.6 |
| + | − | 39.6 |
| + | + | 50.0 |

Because the seeds of Panicum species normally show less dormancy than the seeds of Brachiaria species, we did not expect a clear effect of the treatment on Panicum seeds. Surprisingly however, there was a substantial improvement in the germination due to the aerated nitrate treatment of Panicum seeds as shown in Table VI. Therefore, the method according to the present disclosure may be applicable to a wider range of species than it was originally thought.

It will be clear to those having skill in the art that many changes may be made in the above-described details of preferred embodiments of the present invention without departing from the underlying principles thereof. The scope of the present invention should therefore be determined only by the following claims.

1. A process for treating seeds of grass species to reduce effects of dormancy, said process comprising the steps of:
providing a nitrate salt solution;
aerating the nitrate salt solution;
immersing the seeds in the solution for at least 10 hours; and
draining the seeds after the immersion.

2. The process according to claim 1 wherein the seeds are tropical grass seeds.

3. The process according to claim 1 wherein the seeds are from Brachiaria species.

4. The process according to claim 1 wherein the seeds are previously scarified.

5. The process according to claim 1, wherein the nitrate salt solution is potassium nitrate solution.

6. The process according to claim 1 wherein the potassium nitrate solution has a concentration of 0.2%.

7. The process according to claim 1 wherein the seeds are immersed for a period of between ten and thirty-six hours.

8. The process according to claim 1 wherein the seeds are drained for about 12 hours.

9. The process according to claim 1 wherein the seeds are dried after the draining.

10. The process according to claim 9, wherein the seeds are dried to between 8% and 15% moisture content.

11. The process according to claim 9, wherein the seeds are dried to 12% moisture content.

12. The process according to claim 1 wherein additional ingredients are added during the draining.

13. The process according to claim 12 wherein the additional ingredients are selected from the group consisting of gibberellic acid and smoke extract.

14. The process according to claim 12 wherein the amount of additional ingredients is 500 ml per 10 kg of seeds.

15. The process according to claim 1 wherein additional ingredients are added after the draining.

16. The process according to claim 15 wherein the additional ingredients are selected from the group consisting of gibberellic acid and smoke extract

17. The process according to claim 15 wherein the amount of additional ingredients is 500 ml per 10 kg of seeds.

18. A process for treating seeds to reduce effects of dormancy, said process comprising the steps of:
adding nitrate salt to a heap of seeds;
mixing the salt into the seeds;
covering the seeds with an impermeable sheet; and
allowing the seeds to be in contact with the salt for a period of time.

19. The process according to claim 18 wherein the nitrate salt is potassium salt.

20. The process according to claim 18 wherein the seeds are grass seeds.

21. The process according to claim 18 wherein the seeds are of Brachiaria species.

22. The process according to claim 18 wherein the seeds were previously scarified.

23. The process according to claim 18 wherein additional ingredients are added after the contact of the seeds with the nitrate salt.

24. The process according to claim 23 wherein the additional ingredients are selected from the group consisting of gibberellic acid and smoke extract.

25. The process according to claim 23 wherein the amount of additional ingredients is 500 ml per 10 kg of seeds.

26. The process according to claim 18, wherein the seeds are dried after being in contact with the salt

27. The process according to claim 26, wherein the seeds are dried to between 8% and 14% moisture content

28. The process according to claim 26, wherein the seeds are dried to 12% moisture content.

29. A process for treating grass seeds to reduce effects of dormancy, said process comprising the steps of:
providing a nitrate potassium salt solution, said nitrate potassium salt solution having a concentration of about 0.2%;
aerating the salt solution;
immersing the seeds in the solution for at least 10 hours;
draining the seeds after the immersion; and
drying the seeds after the draining.
